(19) United States
(12) Patent Application Publication
(10) Pub. No.: US 2026/0154374 A1
(43) Pub. Date: Jun. 4, 2026

(54) METHODS AND SYSTEMS FOR GENERATING A SET OF TASKS BASED ON USER CONTEXT PROCESSING

(71) Applicant: Samsung Electronics Co., Ltd., Suwon-si (KR)

(72) Inventors: Sandeep Singh SPALL, Noida (IN); Choice CHOUDHARY, Noida (IN); Deepanshu YADAV, Noida (IN); Tamanna DEVI, Noida (IN); Rohit BHARTI, Noida (IN)

(21) Appl. No.: 19/412,016

(22) Filed: Dec. 8, 2025

Related U.S. Application Data
(63) Continuation of application No. PCT/KR2025/018322, filed on Nov. 7, 2025.

(30) Foreign Application Priority Data
Dec. 3, 2024 (IN) 202411095162

(51) Int. Cl. G06F 18/2113; G06F 16/332; G06F 16/3329

(52) U.S. Cl. CPC G06F 18/2113; G06F 16/3326; G06F 16/33295

(57) ABSTRACT

A method for generating a set of tasks based on user context processing is provided. The method includes determining a user context based on an input data received at a virtual assistant, generating, using a Large Language Sub-system, a workflow based on the user context, wherein the workflow includes one or more actions for at least one of one or more devices and a user, adjusting the workflow in real-time based on an anticipated feedback to generate an adjusted workflow, determining a scale of intent based on at least one of the input data, the user context, the workflow, and the adjusted workflow, and generating the set of tasks for the one or more devices based on at least one of the scale of intent, the user context, the workflow, and the adjusted workflow.

### CROSS REFERENCE TO RELATED APPLICATION

This application is a continuation application, claiming priority under 35 U.S.C. § 365(c), of an International application No. PCT/KR 2025/018322, filed on Nov. 7, 2025, which is based on and claims the benefit of an Indian patent application number 202411095162, filed on Dec. 3, 2024, in the Indian Patent Office, the disclosure of which is incorporated by reference herein in its entirety.

### BACKGROUND

### Field

The disclosure relates to processing of data by a computing device. Particularly, the disclosure relates to a field of virtual assistants for one or more devices. More particularly, the disclosure relates to generating a set of tasks based on user context processing.

### Description of Related Art

The following description of the related art is intended to provide a background information pertaining to the field of disclosure. This section may include certain aspects of the art that may be related to various features of the disclosure. However, it should be appreciated that this section is used only to enhance the understanding of the reader with respect to the disclosure, and shall not in any manner be construed to be admissions of the prior art.

The digital devices of current generation are generally provided with a virtual assistant which is able to perform certain tasks based on command received from the user of such digital devices. For instance, now a days, most of the digital devices are integrated with voice assistants to collect voice inputs from users and implement various functions based on the collected voice inputs. Therefore, the existing virtual assistants are provided with capabilities of doing certain tasks based on the user inputs received. However, due to increasing use and popularity of such virtual assistants, such virtual assistants are required to be improved. There exists a need for the virtual assistants to become efficient for performing complex tasks, this requires a deeper understanding of the user input and the types of actions required to be performed. The conventional virtual assistants have limited understanding of natural language variations.

Conventionally, the virtual assistants are combined with the power of machine learning techniques and artificial intelligence models for enabling better understanding of the language received from the user and has been able to provide better understanding of the received user context. Due to usage of such techniques and models, the existing virtual assistants are able to properly understand single queries and understand the actions required to be performed. These existing virtual assistants are able to perform simple tasks on one device combined with tasks being performed on other devices as well. However, such conventional virtual assistants are unable to efficiently understand the inputs from the user when such received inputs become complex due to reasons such as multiple contextual reference, and multiple actions that may be required to be performed. The conventional virtual assistants would be unable to perform the complex tasks due to lack of understanding of the intention of the user based on the received inputs. The existing voice assistants are unable to analyze the voice inputs in different situations such as due to different dialects and accents, different phrases for the same input, switching between different languages within a single voice input, usage of slang or informal language for their request, etc. In order to understand the natural way of speaking of the user and the existence of multiple intention of the users within the user inputs, there exists a need in the art for the virtual assistants to understand such complex user inputs and analyze complex intention(s) of the user within such user inputs.

Further, the conventional virtual assistants are unable to understand or retain context during multi-turn conversations due to lack of understanding of the received user inputs and its contextual relevance to the activities being performed by the user. Further, the conventional virtual assistants lack the support for multi-intent queries i.e., when the user input is provided with multiple intentions such as multiple conditions and multiple actions required to be performed on one or more digital devices. The conventional virtual assistants are rigid and require specific prompts for the user input in order to be able to perform various actions, which reduces the flexibility of the virtual assistance. Also, the conventional virtual assistants are unable to efficiently support out-of-turn slot changing e.g., when there are multiple intents within the user input, the conventional virtual assistants are unable to efficiently identify and understand the change in the intent and continues the processing of the user input with the previously recognized intents. Thus, the conventional virtual assistants are unable to efficiently recognize the changing intents of the user within the user inputs. Such limitations affect the overall usability and effectiveness of virtual assistants during their applications.

Therefore, there is a need in the art for a technical solution that can overcome the technical limitations of existing arts.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a system for generating a set of tasks based on user context processing.

Another aspect of the disclosure is to provide a solution for efficiently waking up a virtual assistant and/or for generating multi-context aware processing by the virtual assistant.

Another aspect of the disclosure is to provide a solution for identifying individual user intent(s) from multiple user intents.

Another aspect of the disclosure is to provide a solution which is capable of better understanding of complex multiple intent user queries and responding to such complex multiple intent user queries.

Another aspect of the disclosure is to provide a solution for anticipating user needs and suggesting relevant tasks for generating a multi-device workflow.

Another aspect of the disclosure is to adjust the multi-device workflow based on anticipated feedback of the user.

Another aspect of the disclosure is to provide seamless integration across different devices and different virtual assistants.

Another aspect of the disclosure is to provide a solution for retaining context during multi-turn conversations.

Another aspect of the disclosure is to provide a solution that can provide better understanding of rigid prompts and out-of-turn slot changing.

Another aspect of the disclosure is to provide a solution for preventing false wakeup detection of voice assistants.

Another aspect of the disclosure is to provide a solution for providing recommendation(s) for an action based on intent(s) predicted from a user input.

Additional aspects will be set forth in part in the description which follows and, in part, will be apparent from the description, or may be learned by practice of the presented embodiments.

In accordance with an aspect of the disclosure, a method for generating a set of tasks based on user context processing is provided. The method includes determining a user context based on an input data received at a virtual assistant, generating, using a Large Language Sub-system, a workflow based on the user context, wherein the workflow includes one or more actions for at least one of one or more devices and a user, adjusting the workflow in real-time based on an anticipated feedback to generate an adjusted workflow, determining a scale of intent based on at least one of the input data, the user context, the workflow, and the adjusted workflow, and generating the set of tasks for the one or more devices based on at least one of the scale of intent, the user context, the workflow, and the adjusted workflow.

In an aspect of the disclosure, the determining the user context includes identifying, at least one of a current user activity and a user intent.

In another aspect of the disclosure, the determining the user context includes receiving one or more multi-intent utterances in the input data and then recognizing one or more single intents from the one or more multi-intent utterances using a Large Language sub-system (LLS) denoiser engine.

In another aspect of the disclosure, the recognizing the one or more single intents includes removing, using the LLS denoiser engine, a background noise from the one or more multi-intent utterances, and then recognizing, using the LLS denoiser engine, the one or more single intents based on at least one of the removing the background noise and a transcription of the one or more multi-intent utterances.

In another aspect of the disclosure, each single intent from the one or more single intents is one of a wake-up intent and a non-wake up intent, wherein the wake-up intent is an intent to initiate the virtual assistant and the non-wake up intent is an intent for performing the one or more actions.

In another aspect of the disclosure, the method further includes selecting the one or more devices based on the one or more single intents for performing the one or more actions.

In another aspect of the disclosure, the scale of intent is determined to recognize a complexity for executing the workflow.

In another aspect of the disclosure, the method further includes identifying an input requirement for executing the workflow based on the scale of intent.

In another aspect of the disclosure, the anticipated feedback includes a data related to at least one of a resource availability, one or more user interactions with one or more devices and a vector database, wherein the one or more user interactions includes at least one of one or more past interactions, one or more current interactions, one or more predicted interactions.

In another aspect of the disclosure, the vector database is generated based at least on a knowledge graph construction, and an embedding model training.

In another aspect of the disclosure, for the knowledge graph construction, the method further includes logging, one or more events associated with the one or more user interactions. Then the method includes observing, a user interaction based on an analysis of the one or more events and the one or more user interactions. Then the method involves recognizing, a pattern based on at least one of a frequency of the user interaction, and one or more contexts associated with the one or more events. Then the method leads to generating, a relevancy score based on a set of parameters comprising at least one of a recency of the one or more user interactions, and a time spent during the one or more user interactions. Then the method includes recognizing one or more preferred user interactions based on the relevancy score and the pattern to construct the knowledge graph. Lastly, for the knowledge graph construction, the method involves storing, the knowledge graph in the vector database.

In another aspect of the disclosure, the input data includes at least one of an audio input received from the user, a textual input received from the user, a video input received from the user, and a pre-stored information associated with the anticipated feedback.

In accordance with another aspect of the disclosure, a system for generating a set of tasks based on user context processing is provided. The system includes memory, comprising one or more storage media, storing instructions, and one or more processors communicatively coupled to the memory, wherein the instructions, when executed by the one or more processors individually or collectively, cause the system to determine a user context based on an input data received at a virtual assistant, generate using a Large Language Sub-system, a workflow based on the user context, wherein the workflow includes one or more actions for at least one of one or more devices and a user, adjust the workflow in real-time based on an anticipated feedback to generate an adjusted workflow, determine a scale of intent based on at least one of the input data, the user context, the workflow, and the adjusted workflow, and generate the set of tasks for the one or more devices based on at least one of the scale of intent, the user context, the workflow, and the adjusted workflow.

In accordance with another aspect of the disclosure, one or more non-transitory computer-readable storage media storing one or more computer programs including computer-executable instructions that, when executed by one or more processors of an electronic device individually or collectively, cause the electronic device to perform operations is provided. The operations include determining a user context based on an input data received at a virtual assistant, generating, using a Large Language Sub-system, a workflow based on the user context, wherein the workflow includes one or more actions for at least one of one or more devices and a user, adjusting the workflow in real-time based on an anticipated feedback to generate an adjusted workflow, determining a scale of intent based on at least one of the input data, the user context, the workflow, and the adjusted workflow, and generating the set of tasks for the one or more devices based on at least one of the scale of intent, the user context, the workflow, and the adjusted workflow.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with accompanying drawings, in which:

FIG. 1 illustrates a block diagram of a system for generating a set of tasks based on user context processing, according to an embodiment of the disclosure;

FIG. 2A illustrates another block diagram of another system 200 for generating the set of tasks based on user context processing according to an embodiment of the disclosure;

FIG. 2B illustrates a block diagram depicting an interaction of an interaction service with a user interface, according to an embodiment of the disclosure;

FIG. 3 illustrates a signaling flow diagram depicting an illustration of flow of signals between the components of the system, according to an embodiment of the disclosure;

FIG. 4 illustrates a flow diagram depicting a method for generating the set of tasks based on user context processing, according to an embodiment of the disclosure;

FIG. 5 illustrates a use case for generating the set of tasks based on user context processing, according to an embodiment of the disclosure; and

FIG. 6 illustrates a use case for generating the set of tasks based on user context processing, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The ensuing description provides embodiments only, and is not intended to limit the scope, applicability, or configuration of the disclosure. Rather, the ensuing description of the embodiments will provide those skilled in the art with an enabling description for implementing an embodiment. It should be understood that various changes may be made in the function and arrangement of elements without departing from the scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional operations not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a Digital Signal Processing (DSP) core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the disclosure. More specifically, the processor or processing unit is a hardware processor.

As used herein, “a user equipment,” “a user device,” “a smart-user-device,” “a smart-device,” “an electronic device,” “a mobile device,” and “a device” may be any electrical, electronic and/or computing device or equipment, capable of implementing at least some of the features of the disclosure. The user equipment/device may include, but is not limited to, a mobile phone, a smart phone, a laptop, a general-purpose computer, a desktop, a personal digital assistant, a tablet computer, a wearable device or any other computing device which is capable of implementing at least some of the features of the disclosure.

As used herein, “storage unit,” “memory unit,” or “memory” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As used herein “interface” or “user interface refers to a shared boundary across which two or more separate components of a system exchange information or data. The interface may also be referred to a set of rules or protocols that define communication or interaction of one or more modules or one or more units with each other, which also includes the methods, functions, or procedures that may be called.

All modules, units, components used herein, unless explicitly excluded herein, may be software modules or hardware processors, the processors being a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASIC), Field Programmable Gate Array circuits (FPGA), any other type of integrated circuits, etc.

It is pertinent to note that the method(s), as disclosed herein to provide the solution as disclosed in the disclosure, depending on implementation(s), may be performed by electronic device(s) with or without utilizing one or more artificial intelligence models.

Furthermore, as used herein, a “processing unit” or “processor” or “operating processor” may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an artificial intelligence (AI)-dedicated processor such as a neural processing unit (NPU).

One or more of the plurality of modules may be implemented through an AI model. A function associated with AI may be performed through the non-volatile memory, the volatile memory, and the processor.

The one or the plurality of processors control the processing of the input data in accordance with a predefined operating rule or artificial intelligence (AI) model stored in the non-volatile memory and the volatile memory. The predefined operating rule or artificial intelligence model is provided through training or learning.

It may be noted that in the disclosure, various techniques may be implemented for analyzing utterance(s) of the user. For analyzing the utterances of the user in case of voice utterances, an electronic device may receive a speech signal such as an analog signal, via input devices such as a microphone. Then the received speech signal may be converted into computer readable text using an automatic speech recognition (ASR) model. The intent of the user for any utterance may be obtained by interpreting the converted computer readable text using a natural language understanding (NLU) model. The ASR model or NLU model may be an artificial intelligence model. The artificial intelligence model may be processed by an artificial intelligence-dedicated processor designed in a hardware structure specified for artificial intelligence model processing. The artificial intelligence model may be obtained by training.

Language understanding is a technique for recognizing and applying/processing human language/text and includes, e.g., natural language processing, machine translation, dialog system, question answering, or speech recognition/synthesis.

Moreover, in an implementation, for visual understanding of an information say from user interface(s) (UI) and/or infographic(s), an image data as an input is received at an artificial intelligence model. The artificial intelligence model may be obtained by training for providing the visual understanding. As used herein “visual understanding” is a technique for recognizing and processing things as does human vision and includes, e.g., object recognition, object tracking, image retrieval, human recognition, scene recognition, three-dimensional (3D) reconstruction/localization, and/or image enhancement etc.

Also, for identifying and recognizing intentions, preferred interactions of a user of electronic device(s), an artificial intelligence model may be utilized. For this purpose, a processor may perform a pre-processing operation on a data to convert the data into a form appropriate for use as an input for the artificial intelligence model. The artificial intelligence model may be obtained by training for providing a reasoning prediction. As used herein, the “reasoning prediction” is a technique of logically reasoning and predicting by determining information and includes, e.g., knowledge-based reasoning, optimization prediction, and/or preference-based planning or recommendation etc.

Also, as used herein, the term “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation. The neural network computation involves computation between a result of computation by a previous layer and the plurality of weight values.

Here, being provided through learning means that, by applying a learning algorithm(s) to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers, such as long short-term memory (LSTM) layers. Each layer may have a plurality of weight values and may perform a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

Also, a learning algorithm refers to a method for training a device (for example, a robot) using a plurality of learning data to cause, allow, or control the device to make a determination or prediction. Examples of learning algorithms include, but are not limited to, supervised learning, unsupervised learning, semi-supervised learning, or reinforcement learning.

As used herein, a “virtual assistant” may refer to a digital assistant such as a voice assistant which provides assistance to its users by responding to the queries made and processing certain tasks based on the queries. The queries made to such virtual assistants may be user inputs made by way of voice input, textual inputs, multimedia inputs and/or any such other input as appreciated by a person skilled in the art. Also, the virtual assistant may be a software component that can perform a range of tasks or services for a user based on user inputs such as commands or questions.

In order to overcome the limitations and shortcomings of the prior known solutions, the disclosure provides a solution for generating a set of tasks based on user context processing as has been further described in the foregoing description. Briefly, the disclosure provides determination of a user context based on received inputs by the virtual assistants, and based on such user contexts, a workflow is generated which comprises one or more actions for the device(s) and the user(s) of such device(s). Then, the workflow is adjusted based on anticipated feedback. The disclosure then encompasses determining a scale of intent based on received input data, user context, the workflow, and the adjusted workflow. Thereafter, based on at least one of the scale of intent, the user context, the workflow, and the adjusted workflow, a set of tasks is generated for the one or more devices. The above technical solution has only been described briefly and a detailed description (with reference to figures) explaining the same solution has been provided in the foregoing description.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

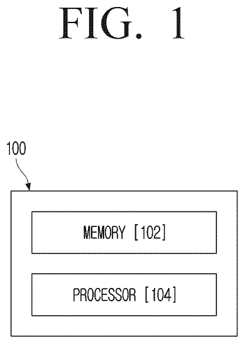

FIG. 1 illustrates a block diagram of a system for generating a set of tasks based on user context processing, according to an embodiment of the disclosure.

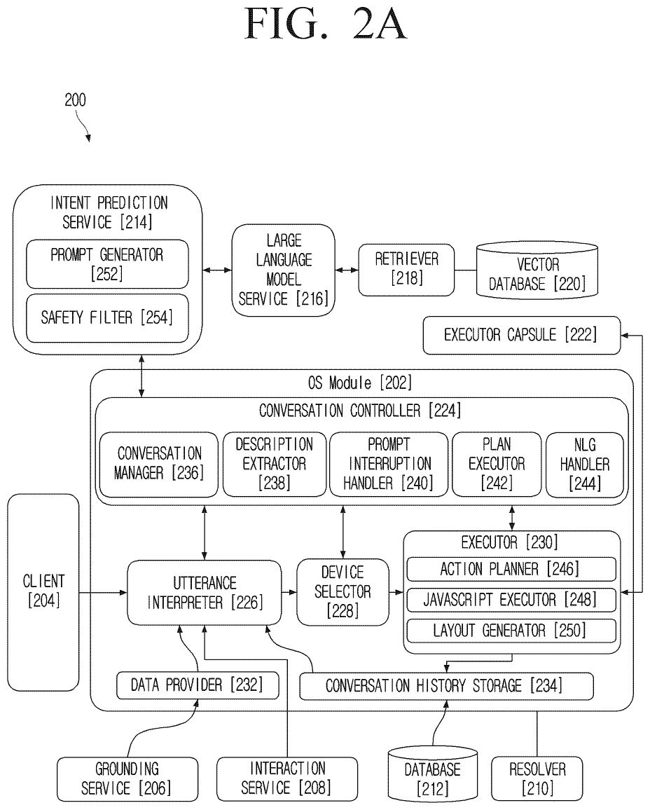

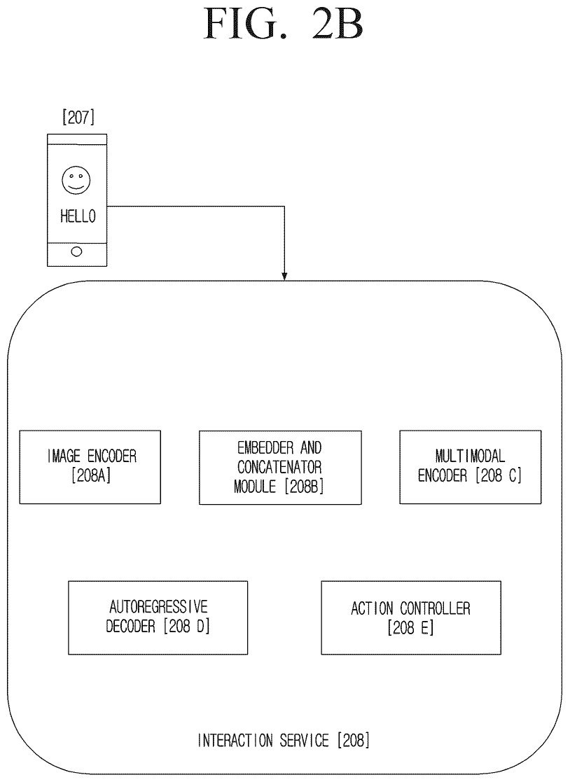

Referring to FIG. 1, a block diagram of a system 100 for generating a set of tasks based on user context processing is illustrated in accordance with embodiments of the disclosure. As shown in the figure, the system 100 comprises memory 102 and a processing unit 104. Also, all of the components/units of the system 100 may be assumed to be connected to each other unless otherwise indicated below. Also, in FIG. 1 only a few units are shown, however, the system 100 may comprise multiple such units, or the system 100 may comprise any such number of said units, as may be required to implement the features of the disclosure. Some units that may be provided within the system 100 have been provided by way of an illustration in the FIG. 2A. Further, in an embodiment, the system 100 may reside in and/or connected to and/or in communication with a user device (may also be referred herein as a user equipment or a UE) to implement the features of the disclosure. In another embodiment, the system 100 may reside in a server or a network entity.

In operation, the processing unit 104 is configured to determine a user context based on an input data received at a virtual assistant. The virtual assistant is a digital assistant such as a voice assistant that may be provided in device(s) for performing certain functions like an assistant that may also respond to the queries made by a user of the user device based on processing of such certain functions. The user context may be a context referred by the user which is determined based on the input data, and the user context may be for a single reference to the referred context and may also be for multiple references for multiple contexts referred by the user. In one implementation of the solution as provided by the disclosure, for determining the user context, the processing unit 104 is configured to identify at least one of a current user activity and a user intent. For example, in an event where an input data comprising a request to play a particular song at a user device is received at the processing unit 104, in such event the processing unit 104 is configured to identify a current user activity and/or a user intent based on such request. In such example, the processing unit 104 may identify: 1) the current user activity as using an audio streaming platform at the user device, and 2) the user intent to play a particular type of song such as a sad song. Further, in such example, the processing unit 104 is configured to determine the user context based on the identification of the usage of the audio streaming platform at the user device and the user intent to play the sad song.

In one implementation of the disclosure, the input data may be received from the user in form of an audio input, a textual input, and/or a video input, however the disclosure is not limited thereto and the input data may be received in any form as appreciated by a person skilled in the art in light of the disclosure. Also, such input data may be received in form of a pre-stored information associated with an anticipated feedback which is explained later in the description. Such pre-stored information may be stored in the memory 102 in one example, and in other examples may be stored in other storage/memory components as appreciated by a person skilled in the art in light of the disclosure.

Moreover, for the determination of the user context, the processing unit 104 may be configured to receive one or more multi-intent utterances in the input data. The one or more multi-intent utterances may refer to the utterances such as at least one of one or more textual utterances, and one or more voice utterances that may be received in the input data. The one or more multi-intent utterances may be the command(s) or query(ies) given by the user in the form of input data. For instance, a textual utterance may include command(s) given by a user in form of a textual input, and a voice utterance may include command(s) given by the user in form of an audio input. Such command(s) or query(ies) may comprise multiple intentions related to processing of the queries and action items given by the user. Then based on the received one or more multi-intent utterances, the processing unit 104 may be configured to recognize one or more single intents from the one or more multi-intent utterances using a Large Language sub-system (LLS) denoiser engine. Such single intents when recognized, enable recognizing individual intentions of the user for processing a particular query and/or command in the input data.

In an embodiment of the disclosure, for recognizing the one or more single intents, the processing unit 104 may be configured to remove, using the LLS denoiser engine, a background noise from the one or more multi-intent utterances. This removal of background noise removes unnecessary clutter in the received user input and help in recognition of the single intents. Thereafter, the processing unit 104 may be configured to recognize, using the LLS denoiser engine, the one or more single intents based on at least one of the removing the background noise and a transcription of the one or more multi-intent utterances.

Also, each single intent from the one or more single intents is one of a wake-up intent and/or a non-wake up intent. The wake-up intent may be an intent to initiate the virtual assistant. Similarly, the non-wake up intent may be an intent for performing the one or more actions. This divides the multiple intents of the multi-intent utterances into a wake-up command and/or one or more action/query commands. Such division helps in correct analysis of the intention of the user to wake up the virtual assistant. Also, due to implementation of such solutions as provided by the disclosure, the technical problems of false detection of wake-up command, and/or false wake-up of the virtual assistants are solved. More specifically, in an implementation, when a user interacts with the virtual assistant using a user input such as a text, a voice, or a video. The user input is analyzed to understand intention and context of the user. Thereafter, based on the intention and context of the user, the user's intended action or request is determined. The user's intended action or the request is then identified as a valid request or an invalid request for waking up the virtual assistant. In an implementation, the valid request is identified upon detection of a capability of the virtual assistant to perform an action corresponding to the user's intended action or the request. Also, in such implementation, the invalid request is identified upon detection of an incapability of the virtual assistant to perform the action corresponding to the user's intended action or the request. Therefore, the invalid request is detected as a false wake-up command for the virtual assistant, and the virtual assistant is not activated to avoid false wake-up scenarios.

Also, in an implementation of the disclosure, the processing unit 104 is configured to select the one or more devices based on the one or more single intents for performing the one or more actions. The one or more devices may be selected based on the recognition of the one or more single intents and such one or more devices may be the devices on/for which the set of tasks is required to be performed/executed.

Continuing further, on determination of the user context, the processing unit 104 is configured to generate, using a Large Language Sub-system, a workflow based on the user context. The workflow comprises one or more actions for at least one of one or more devices and the user. The large language sub-system may be an AI/machine learning (ML) based model which may also be pre-trained specifically or fine-tuned for different purposes such as various operations to be performed by the system 100. The large language sub-system generates the workflow which in one example may be a list for one or more actions/queries that has to be performed in a particular manner and/or in a particular sequence.

Thereafter, the processing unit 104 is configured to adjust the workflow in real-time based on the anticipated feedback to generate an adjusted workflow. In the above example, the list for one or more actions/queries may be adjusted based on the anticipated feedback and results in formation of a new workflow.

In some implementations of the disclosure, the anticipated feedback may be a set of data. Such set of data i.e., the anticipated feedback may comprise a data related to at least one of a resource availability, one or more user interactions with the one or more devices and a vector database. The one or more user interactions may comprise at least one of one or more past interactions, one or more current interactions, and one or more predicted interactions. The anticipated feedback acts as a condition or a pre-requisite based on which the workflow is adjusted.

In further implementations of the disclosure, the vector database of the anticipated feedback may be generated based at least on a knowledge graph construction, and an embedding model training. The embedding model training may be done by one or more embedding models which may use numerical representations of real-world objects which may be used by AI/ML systems or sub-systems for utilizing complex knowledge domains for understanding real-world data domains. The embedding model training may also be done by quantifying chunks of data and then converting them into vector format which may also assist in the knowledge graph construction and vector representation for vector database generation. In such implementations, for the knowledge graph construction, the processing unit 104 may be configured to log one or more events associated with the one or more user interactions. Then the processing unit 104 may observe a user interaction based on an analysis of the one or more events and the one or more user interactions. Further, the processing unit 104 may be configured to recognize, a pattern based on at least one of a frequency of the user interaction, and one or more contexts associated with the one or more events. Then, the processing unit 104 may be configured to generate a relevancy score based on a set of parameters. The relevancy score may comprise a recency of the one or more user interactions, and/or a time spent by the user during the one or more user interactions. Then, based on the relevancy score and the pattern, the processing unit 104 may be configured to recognize one or more preferred user interactions to construct the knowledge graph. The processing unit 104 may also be configured to store the knowledge graph in the vector database such as using the memory 102.

Then, based on the above, the processing unit 104 is configured to determine a scale of intent based on at least one of the input data, the user context, the workflow, and the adjusted workflow. In an implementation of the disclosure, the scale of intent may be determined to recognize a complexity for executing the workflow. In another implementation of the disclosure, the processing unit 104 may also be configured to identify an input requirement for executing the workflow based on the scale of intent. Since, the multi-intent utterances may also be partial prompt, i.e., with missing details/intents, then the processing unit 104 is configured to determine the scale of intent in such cases. For determination of the scale of intent, an assessment is done on an ability of the user. In cases a partial prompt is received from the user, the processing unit 104 identifies the single intents from the multi-intent utterances and then accordingly identifies if the condition and the task/action is incomplete. The processing unit 104 may utilize a model trained based on learned mapping to identify the input requirement for execution of the workflow. The model determines based on learned mapping the input requirement associated with user behaviour, i.e., what is required from the user as minimal input for corresponding partial prompt completion. The learned mapping may be based on a predefined preset data, and a user pattern of interactions comprising time, place and occasion of the interactions. Thus, in one implementation, the model identifies and/or predicts the input requirement based on an interaction score which is a score allocated to each interaction.

Thereafter, based on at least one of the scale of intent, the user context, the workflow, and the adjusted workflow, the processing unit 104 is configured to generate the set of tasks for the one or more devices. The processing unit 104 may also automatically generate the set of tasks for the one or more devices for performing the actions as required by the user. Such set of tasks may also be performed periodically and repeatedly for example in a set routine.

FIG. 2A illustrates another block diagram of another system for generating the set of tasks based on user context processing according to an embodiment of the disclosure.

Referring to FIG. 2A, another block diagram representation of another system 200 has been depicted in accordance with embodiments of the disclosure. Such system 200 may be comprised within the system 100 in one embodiment and may also in other embodiments be connected with the system 100 for implementation of the solution provided by the disclosure. Such connections between the system 100 and the system 200 may be made by different protocols and interfaces as may be appreciated by a person skilled in the art and has not been provided herein for the sake of brevity, however, the same shall be construed to be well within the scope of the disclosure in the implementations where the system 200 may be implemented for providing the solutions of the disclosure. It may be noted that the processing unit 104 of the system 100 may be connected with the system 200 and other components comprised within the system 200 and may cause the system 200 and such components within the system 200 to implement the functions provided by the disclosure.

The system 200 may comprise an OS module 202, a client 204, a grounding service 206, an interaction service 208, a resolver 210, a database 212, an intent prediction service (IPS) 214, a large language model (LLM) service 216, a retriever 218, a vector database 220, and an executor capsule 222.

The OS module 202 may comprise a conversation controller 224, an utterance interpreter 226, a device selector 228, an executor 230, a data provider 232, and a conversation history storage 234. In an implementation, the OS module 202 is a module that performs one or more functionalities of the virtual assistant.

The conversation controller 224 of the OS module 202 may further comprise a conversation manager 236, a description extractor 238, a prompt interruption handler 240, a plan executor 242, and an NLG handler 244. The conversation controller 224 may be the component which handles the interaction of the virtual assistant with the user. Such conversation controller 224 may in one example be configured to receive user inputs such as in terms of input data from the user or the client 204 either directly in one example or indirectly through the utterance interpreter 226 in another example. The conversation manager 236 may be responsible for receiving the input data specifically related to the multi-intent utterances and/or the one or more single intents within the multi-intent utterances. Further, the conversation manager 236 may also be responsible for sending a response dialogue or a representative view to the user or the client 204. The description extractor 238 is responsible for extraction of a description of a condition or an action such as condition type, action type, tag associated with the routine, etc. The prompt interruption handler 240 utilizes a large language model (LLM) for analyzing a user context related to an instruction for determining a wakeup intent and a non-wakeup intent before providing the instruction to perform an action to the virtual assistant that may lead to false wakeup detection of the virtual assistant due to the non-wake up intent. Due to this detection of false wakeup, the virtual assistant reduces unnecessary interruptions and improves the overall user experience. The plan executor 242 and the NLG handler 244 may in conjunction with the executor 230 to perform certain iterations for the execution of the set of tasks that may be generated. It may be noted that in some examples, the conversation controller 224 may be configured to be trained based on the large language models.

The utterance interpreter 226 may be a component responsible for identification of the multi-intent utterances received by the user devices and analyzing the received input data. The utterance interpreter 226 may also be responsible for identification of the one or more single intents from the multi-intent utterances. In some examples, the utterance interpreter 226 may also act as an interpreter for data transferred within and/or between the conversation controller 224, the client 204 and the utterance interpreter 226. In some examples, the utterance interpreter 226 may provide automation facilities for generating the set of tasks in a routine manner. Also, in another example, the utterance interpreter 226 may also be responsible for intent recommendation and collection of user contexts. The utterance interpreter 226 may receive the historical interactions of the user with the virtual assistants and the results provided during such historical interactions. Also, the utterance interpreter 226 may also receive from the data provider 232, information associated with data grounding and the one or more devices that may be connected to the user device that may be running the virtual assistant.

The device selector 228 may be a component responsible for selection of the one or more devices for which the set of tasks has been generated. After selection of the one or more devices, the device selector 228 transmits the selection information to the executor 230 for execution of the set of tasks.

The executor 230 of the OS module 202 may further comprise an action planner 246, a JavaScript Executor 248, and a Layout Generator 250. The executor 230 is responsible for execution of the processed command and for further execution of the generated set of tasks. The executor 230 may store the result of the execution such as the utterances, contexts (such as the device states, requests), and the results (such as dialogues, views, and result data that would be provided to the user device) in the conversation history storage 234.

The data provider 232 may be connected with the utterance interpreter 226 and the grounding service 206. Similarly, the conversation history storage 234 may be connected with the executor 230, the utterance interpreter 226, and the database 212.

The client 204 as provided may refer to a user device through which the virtual assistant will receive user inputs and respond to.

The grounding service 206 may refer to a component responsible for verification of the information being processed by the virtual assistant. In one example, the grounding service may be an intelligent platform used for personalization and provides personalized data such as information associated with the one or more devices that may be connected with the user device on which the virtual assistant may be running. This personalized data such as a data for a smart watch related to sleep detection may help in setting certain tasks associated with the condition being the sleep detection. Accordingly, the grounding service 206 may also be associated with the anticipated feedback.

The interaction service 208 may refer to a component responsible for handling the interaction of the user device by the user and also the virtual assistant. A block diagram depicting an interaction of the interaction service 208 with a user interface 207 is shown in FIG. 2B, in accordance with the embodiments of the disclosure.

FIG. 2B illustrates a block diagram depicting an interaction of an interaction service with a user interface, according to an embodiment of the disclosure.

Referring to FIG. 2B, the interaction service 208 may have an image encoder 208A, an embedder and concatenator module 208B, a multimodal encoder 208C, an autoregressive decoder 208D, and an action controller 208E. The interaction service 208 may be a vision-language model which may understand the user interfaces (UI) and infographics (e.g., from the user interface 207), such as by combining, via the embedder and concatenator module 208B, image embeddings received from the image encoder 208A, and text embeddings received based on a textual input. The Interaction service 208 may be configured to handle various tasks involving the user interfaces (UIs) and infographics. The interaction service 208 may provide question answering, UI navigation, and summarization functionalities to the virtual assistant. Also, the interaction service 208 with the help of other components helps in determination of the user context(s). As depicted in FIG. 2B, the interaction service 208 may have the image encoder 208A and the multimodal encoder 208C which processes embedded text and image features and then their output is provided to the autoregressive decoder 208D to generate a final text output. The final text output may be then utilized by the action controller 208E for performing one or more functions such as for creation of event(s), tracking an action history, and/or tracking a task completion status etc.

The resolver 210 may refer to a component which checks if the set of tasks that has been generated has to executed by the virtual assistant itself, or it may be executed via some another platform. After performing such checks, the resolver 210 causes to execute the set of tasks by the virtual assistant or other platforms and provides fault tolerance in case the set of tasks are not being able to perform by the virtual assistant itself. The resolver 210 may be in direct communication with the conversation controller 224 for implementing the functions of the resolver 210. Also, the resolver 210 may in another example be in connection with the other platforms which may or may not reside within the user device running the virtual assistant.

The database 212 may be a structured collection of data which may store the historical interactions of the user and any other data provided by the conversation history storage 234. The database 212 may act as an external facilitator for extending and organizing the historical interactions between the virtual assistants and the user as provided by the conversation history storage 234.

The Intent Prediction Service (IPS) 214 of the system 200 may further comprise a prompt generator 252, and a safety filter 254. The IPS 214 utilizes the large language model service 216, the retriever 218, and the vector database 220 for predicting the intent of the user and predicting the user interaction. For such prediction, the prompt generator 252 is used to generate a contextually relevant prompt for the large language model service 216 based on historical interactions, preferences of the user, user context and the input data. The preferences of the user are determined based on the knowledge graph construction and the vector database 220, as has also been provided above. Then the generated contextually relevant prompt is provided to the large language model service 216 as a query which provides a list of potential intentions of the user. Such list of potential intentions is then ranked according to a likelihood of matching the intent of the user and irrelevant and inappropriate intentions are filtered out from the list. Then the remaining ranked intentions are provided to the virtual assistants, which may be used for mapping with the received input data which may be used for faster and more reliable processing of the received commands/queries in one example, and in another example be used to provide such recommended intent to the user via the virtual assistants.

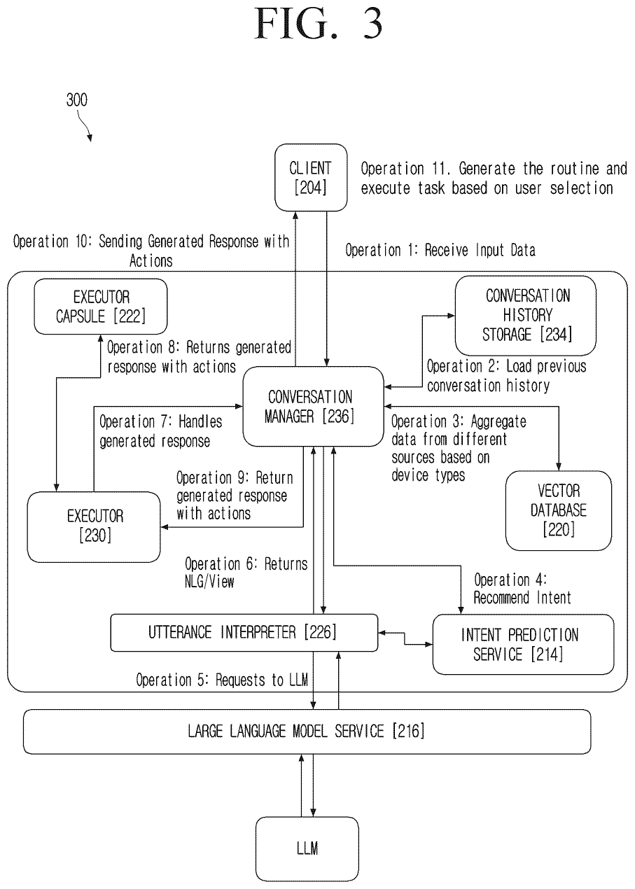

FIG. 3 illustrates a signaling flow diagram depicting an illustration of flow of signals between the components of the system, according to an embodiment of the disclosure.

Referring to FIG. 3, a signaling flow diagram, depicting an illustrative method 300 showing flow of signals between the components of the system 200, is illustrated in accordance with implementations of the disclosure. At operation 1, the conversation manager 236 may receive input data from the client 204. Then, at operation 2, the conversation manager 236 may load the previous conversation history storage 234 for the past interactions between the virtual assistant and the user. Also, at operation 3, the vector database 220 aggregates data from different sources such as based on different device types which may be connected with the user device running the virtual assistant, and the aggregated data is provided to the conversation manager 236. At operation 4, the intent prediction service 214 after processing of the intentions of the user, may provide recommended intentions of the user to the conversation manager 236 in one example. At operation 5, the utterance interpreter 226 in one example may send a request to the LLM service 216 and then the LLM service 216 processes the request using a large language model. Also, at this operation 5, a generated response from the LLM service 216 is provided back to the utterance interpreter 226, which may at operation 6, be further provided to the conversation manager 236. Thereafter, at operation 7, the executor 230 handles and processes the generated response in conjunction with the conversation manager 236. Also, the executor 230 then provides the generated response along with required actions to the executor capsule 222 and the conversation manager 236 at operation 8 and operation 9 respectively. At operation 10, the conversation manager 236 provides the generated response along with the required actions to the client 204 i.e., the user device running the virtual assistant or the virtual assistant itself. Then at operation 11, generation and execution of the set of tasks may be completed by the virtual assistant, such as on selection by the user and/or further commands to execute the set of tasks.

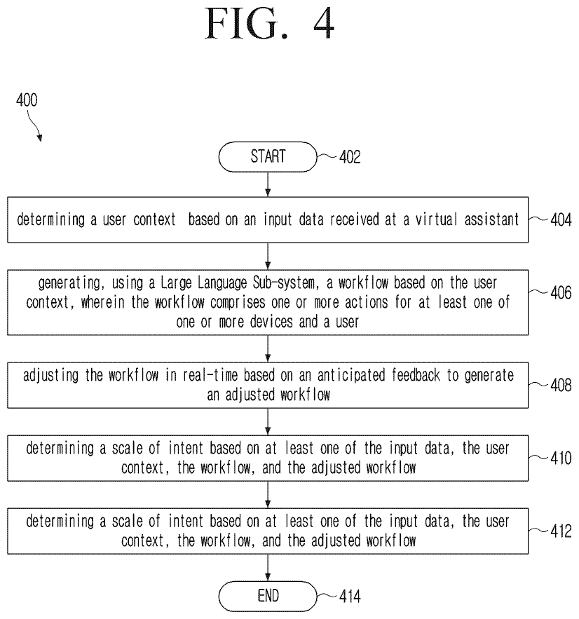

FIG. 4 illustrates a flow diagram depicting a method for generating the set of tasks based on user context processing, according to an embodiment of the disclosure.

Referring to FIG. 4, a flow diagram representation of a method 400 for generating a set of tasks based on user context processing, in accordance with implementations of the disclosure. In an implementation the method 400 may be performed by the system 100. Further, in another implementation the method 400 may be performed by the system 200. Further, in an implementation, the method 400 may be performed by the system 100 in conjunction with the system 200. The method 400 as depicted in FIG. 4 may start at operation 402.

Initially, at operation 404, the method 400 involves determining a user context based on an input data received at a virtual assistant. In an implementation, the input data comprises at least one of an audio input received from the user, a textual input received from the user, a video input received from the user, and a pre-stored information associated with an anticipated feedback.

In one implementation of the disclosure, the determining the user context comprises identifying, at least one of a current user activity and a user intent. Also, in an implementation of the disclosure, for determining the user context the method comprises receiving one or more multi-intent utterances in the input data, and then recognizing one or more single intents from the one or more multi-intent utterances using a Large Language sub-system (LLS) denoiser engine.

Also, the operation of recognizing the one or more single intents comprises removing, using the LLS denoiser engine, a background noise from the one or more multi-intent utterances, and then recognizing, using the LLS denoiser engine, the one or more single intents based on at least one of the removing the background noise and a transcription of the one or more multi-intent utterances.

Also, each single intent from the one or more single intents is one of a wake-up intent and a non-wake up intent, wherein the wake-up intent is an intent to initiate the virtual assistant and the non-wake up intent is an intent for performing the one or more actions.

The method further comprises selecting the one or more devices based on the one or more single intents for performing the one or more actions.

Continuing further, on determination of the user context, at operation 406, the method 400 involves generating, using a Large Language Sub-system, a workflow based on the user context. The workflow comprises one or more actions for at least one of the one or more devices and a user of the user device.

Then, the method 400 leads to operation 408, which comprises adjusting the workflow in real-time based on an anticipated feedback to generate an adjusted workflow. In an implementation of the disclosure, the anticipated feedback may comprise a data related to at least one of a resource availability, one or more user interactions with one or more devices and a vector database, wherein the one or more user interactions comprises at least one of one or more past interactions, one or more current interactions, one or more predicted interactions.

Also, the vector database may be generated based at least on a knowledge graph construction, and an embedding model training.

Moreover, for the knowledge graph construction, the method 400 may also comprise logging, one or more events associated with the one or more user interactions. Then the method 400 may further comprise observing, a user interaction based on an analysis of the one or more events and the one or more user interactions. Then the method 400 involves recognizing, a pattern based on at least one of a frequency of the user interaction, and one or more contexts associated with the one or more events. The method 400 further involves generating, a relevancy score based on a set of parameters comprising at least one of a recency of the one or more user interactions, and a time spent by the user during the one or more user interactions. Then the method 400 may involve recognizing one or more preferred user interactions based on the relevancy score and the pattern to construct the knowledge graph. Then the method 400 may lead to storing, the knowledge graph in the vector database.

Continuing further, at operation 410, the method 400 comprises determining a scale of intent based on at least one of the input data, the user context, the workflow, and the adjusted workflow. In an implementation of the disclosure, the scale of intent may be determined to recognize a complexity for executing the workflow. Also, in an implementation of the disclosure, the method may also comprise identifying an input requirement for executing the workflow based on the scale of intent.

Then, the method 400 leads to operation 412 which comprises generating the set of tasks for the one or more devices based on at least one of the scale of intent, the user context, the workflow, and the adjusted workflow. The method 400 as depicted in FIG. 4 may start at operation 414.

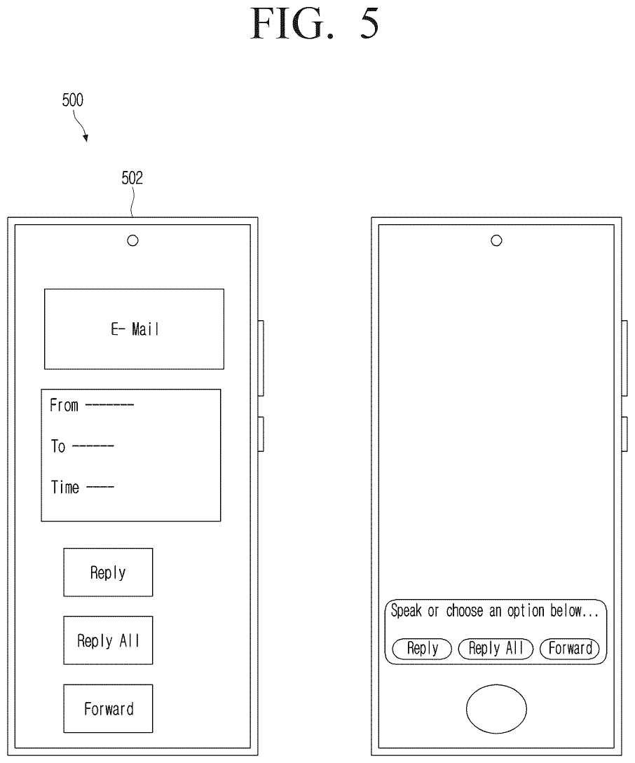

FIG. 5 illustrates a use case for generating the set of tasks based on user context processing, according to an embodiment of the disclosure.

Referring to FIG. 5, a flow diagram illustrating a use case 500 for generating a set of tasks based on user context processing, is provided in accordance with implementation of the disclosure. As illustrated in a user device 502, there are multiple contexts present on the screen of the user device 502 and various options for different actions that the user may have intentions to perform. It may be possible that the user intends to perform the action of replying to the e-mail, replying all senders and recipients for the e-mail, and may also intend to forward said e-mail. The intent recommendation as provided by the disclosure, identifies the possible intents of the user based on the user context provided on the screen and through the input data, and then such recommendations are provided to the user by the virtual assistant. Then on selection of such recommendation based on the received user inputs, the virtual assistants may map the selected intent and the recommended intent and then perform such actions intended by the user.

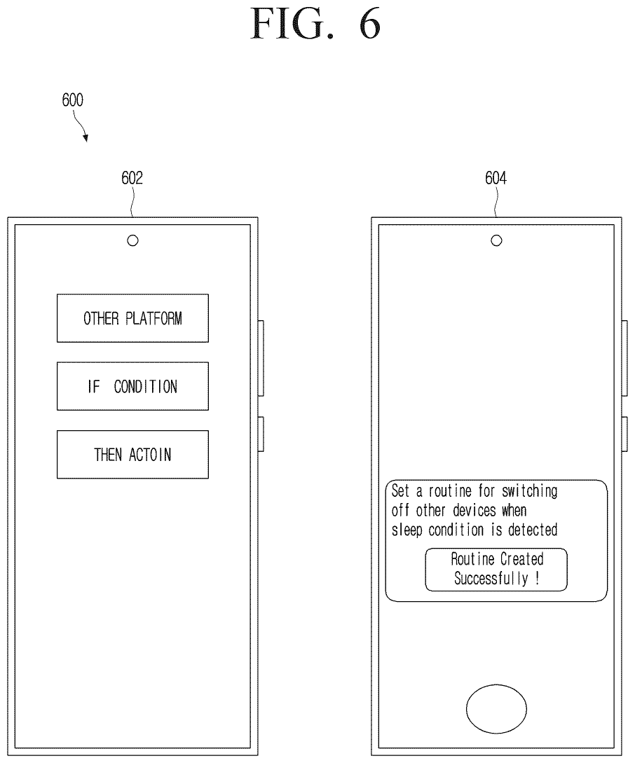

FIG. 6 illustrates a use case for generating the set of tasks based on user context processing, according to an embodiment of the disclosure.

Referring to FIG. 6, a flow diagram illustrating a use case 600 for generating a set of tasks based on user context processing, is provided in accordance with implementation of the disclosure. A user device 602 illustrates a known scenario where the routines or tasks for if-then conditional actions are generated on some platform other than virtual assistant, which takes a lot of time for creating the routines and is often rigid in terms of usability. However, the implementation of disclosure and usage of the virtual assistant as provided enables the user to create/generate a routine/conditional task based on the user inputs received from the user and the virtual assistant itself generates the routine tasks that may be required to be performed.

In another example, as may not be provided in the figures, the virtual assistant as provided by the disclosure may use the other connected platforms for execution of the set of tasks, for example, in case the input data received from the user is related to a command to book a taxi for a specific location, then the virtual assistant using the user context and connection with the other platforms, may also be able to book the taxi using the suitable platform and execute the set of actions accordingly.

Moreover, in one other example, based on the implementation of features of the disclosure, in an event where a user initiates a media streaming platform on a user device to stream a media related to tracking of a status of a tax return, a context is automatically identified by the system 100. The system 100 then automatically provides, recommendation(s) such as “view tax return steps” and/or “run tax return status” etc., over the media streaming platform to perform action(s).

Further, in one example, based on the implementation of features of the disclosure, in an event a user is exercising, the system 100 based on a user pattern may detect that the user is exercising, and a connection of earbuds is active with a user device of the user. The system 100 then may initiate automatically a play music and/or read aloud function at the user device.

Also, in one other example, based on the implementation of features of the disclosure, the system 100 allows a user to initiate request(s) in plain text that identifies trigger(s) and action(s), and then the system 100 facilitates natural language routine creation with suggestion.

Further, in one other example, based on the implementation of features of the disclosure, the system 100 based on a user pattern, connects a user device automatically to Wi-Fi during a specific time period and enables an auto sync function at the user device.

Also, in one other example, based on the implementation of features of the disclosure, the system 100 based on a routine of a user, automatically enables or disables one or more functions at a user device of the user.

It may be noted that the above-mentioned use cases and examples, are provided in accordance with implementations and embodiments of the disclosure, and shall not in any manner be construed to be limiting the scope of the disclosure to the provided use-cases only. As would be appreciated, there may also be several use cases and implementations, and embodiments of the disclosure, which may not be provided herein, however, the same shall be included within the scope of the disclosure.

Yet another aspect of the disclosure may relate to a non-transitory computer readable storage medium storing instructions for generating a set of tasks based on user context processing. The instructions include executable code which, when executed by a processing unit 104 of a system 100 causes the processing unit 104 to determine a user context based on an input data received at a virtual assistant. Further, the execution of the instruction causes the processing unit 104 to generate, using a Large Language Sub-system, a workflow based on the user context. The workflow comprises one or more actions for at least one of one or more devices and a user. Further, the execution of the instruction causes the processing unit 104 to adjust the workflow in real-time based on an anticipated feedback to generate an adjusted workflow. Further, the execution of the instruction causes the processing unit 104 to determine a scale of intent based on at least one of the input data, the user context, the workflow, and the adjusted workflow. Further, the execution of the instruction causes the processing unit 104 to generate the set of tasks for the one or more devices based on at least one of the scale of intent, the user context, the workflow, and the adjusted workflow. For example, as shown in the user device 604, when the user inputs are provided for the generation of routine for switching off multiple devices based on sleep detection condition, then in one example, the virtual assistants may gather such information associated with the one or more devices connected with the user device 604 and then accordingly receive an information for sleep detection such as from a connected watch device and then accordingly switch the power for another connected device say a lamp, a television, or a fan, etc.

As is evident from the above, the disclosure provides a technically advanced solution for generating a set of tasks based on user context processing. The present solution provides recognition of one or more single intents from the one or more multi-intent utterances which enables the virtual assistants to clearly identify each intention of the user from the multiple intentions. Further, the disclosure provides a solution that effectively understands and responds to complex multi-intent utterances. Also, the present solution determines the user context from the complex multi-intent utterances that may help in one example for managing and controlling one or more devices. The disclosure provides a solution that creates a cohesive ecosystem of devices and services for users based on the user context.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for generating a set of tasks based on user context processing, the method comprising:
determining a user context based on an input data received at a virtual assistant;
generating, using a Large Language Sub-system, a workflow based on the user context, wherein the workflow comprises one or more actions for at least one of one or more devices and a user;
adjusting the workflow in real-time based on an anticipated feedback to generate an adjusted workflow;
determining a scale of intent based on at least one of the input data, the user context, the workflow, and the adjusted workflow; and
generating the set of tasks for the one or more devices based on at least one of the scale of intent, the user context, the workflow, and the adjusted workflow.

2. The method as claimed in claim 1, wherein the determining the user context comprises identifying, at least one of a current user activity and a user intent.

3. The method as claimed in claim 1, wherein the determining the user context comprises:
receiving one or more multi-intent utterances in the input data; and
recognizing one or more single intents from the one or more multi-intent utterances using a Large Language sub-system (LLS) denoiser engine.

4. The method as claimed in claim 3, wherein the recognizing the one or more single intents comprising:
removing, using the LLS denoiser engine, a background noise from the one or more multi-intent utterances; and
recognizing, using the LLS denoiser engine, the one or more single intents based on at least one of the removing the background noise and a transcription of the one or more multi-intent utterances.

5. The method as claimed in claim 3,
wherein each single intent from the one or more single intents is one of a wake-up intent and a non-wake up intent, and
wherein the wake-up intent is an intent to initiate the virtual assistant and the non-wake up intent is an intent for performing the one or more actions.

6. The method as claimed in claim 3, the method further comprises selecting the one or more devices based on the one or more single intents for performing the one or more actions.

7. The method as claimed in claim 1, wherein the scale of intent is determined to recognize a complexity for executing the workflow.

8. The method as claimed in claim 1, the method comprises identifying an input requirement for executing the workflow based on the scale of intent.

9. The method as claimed in claim 1,
wherein the anticipated feedback comprises a data related to at least one of a resource availability, one or more user interactions with one or more devices and a vector database, and
wherein the one or more user interactions comprises at least one of one or more past interactions, one or more current interactions, one or more predicted interactions.

10. The method as claimed in claim 9, wherein the vector database is generated based at least on a knowledge graph construction, and an embedding model training.

11. The method as claimed in claim 10, wherein for the knowledge graph construction, the method comprises:
logging, one or more events associated with the one or more user interactions;
observing, a user interaction based on an analysis of the one or more events and the one or more user interactions;
recognizing, a pattern based on at least one of a frequency of the user interaction, and one or more contexts associated with the one or more events;
generating, a relevancy score based on a set of parameters comprising at least one of a recency of the one or more user interactions, and a time spent during the one or more user interactions;
recognizing one or more preferred user interactions based on the relevancy score and the pattern to construct the knowledge graph; and
storing, the knowledge graph in the vector database.

12. The method as claimed in claim 1, wherein the input data comprises at least one of an audio input received from the user, a textual input received from the user, a video input received from the user, and a pre-stored information associated with the anticipated feedback.

13. A system for generating a set of tasks based on user context processing, the system comprising:
memory, comprising one or more storage media, storing instructions; and
one or more processors communicatively coupled to the memory,
wherein the instructions, when executed by the one or more processors individually or collectively, cause the system to:
determine a user context based on an input data received at a virtual assistant,
generate using a Large Language Sub-system, a workflow based on the user context, wherein the workflow comprises one or more actions for at least one of one or more devices and a user,
adjust the workflow in real-time based on an anticipated feedback to generate an adjusted workflow,
determine a scale of intent based on at least one of the input data, the user context, the workflow, and the adjusted workflow, and
generate the set of tasks for the one or more devices based on at least one of the scale of intent, the user context, the workflow, and the adjusted workflow.

14. The system of claim 13, wherein the instructions that, when executed by the one or more processors individually or collectively, further cause the system to identify, at least one of a current user activity and a user intent.

15. The system of claim 13, wherein the instructions that, when executed by the one or more processors individually or collectively, further cause the system to:
receive one or more multi-intent utterances in the input data; and
recognize one or more single intents from the one or more multi-intent utterances using a Large Language sub-system (LLS) denoiser engine.

16. The system of claim 15, wherein the instructions that, when executed by the one or more processors individually or collectively, further cause the system to:
remove, using the LLS denoiser engine, a background noise from the one or more multi-intent utterances; and
recognize, using the LLS denoiser engine, the one or more single intents based on at least one of the removing the background noise and a transcription of the one or more multi-intent utterances.

17. The system of claim 15,
wherein each single intent from the one or more single intents is one of a wake-up intent and a non-wake up intent, and
wherein the wake-up intent is an intent to initiate the virtual assistant and the non-wake up intent is an intent for performing the one or more actions.

18. The system of claim 15, wherein the instructions that, when executed by the one or more processors individually or collectively, further cause the system to select the one or more devices based on the one or more single intents for performing the one or more actions.

19. The system of claim 16, wherein the instructions that, when executed by the one or more processors individually or collectively, further cause the system to:
load a previous conversation history storage for past interactions between the virtual assistant and the user, and
aggregate data from different sources such as based on different device types which may be connected with the user device running the virtual assistant.

20. The system of claim 13, wherein the instructions that, when executed by the one or more processors individually or collectively, further cause the system to:
check if the set of tasks that has been generated has to executed by the virtual assistant itself, and
determine fault tolerances related to the set of tasks in case the set of tasks are not able to be perform by the virtual assistant itself.
